(19) United States
(12) Patent Application Publication
(10) Pub. No.: US 2021/0300497 A1
(43) Pub. Date: Sep. 30, 2021

(54) SADDLE RIDE TYPE VEHICLE AND CONTROL APPARATUS

(71) Applicant: HONDA MOTOR CO., LTD., Tokyo (JP)

(72) Inventors: Hiroshi Maeda, Tokyo (JP); Kazuyuki Fukaya, Tokyo (JP); Kineo Tomura, Tokyo (JP); Hiroaki Uchisasai, Tokyo (JP); Takayuki Abe, Tokyo (JP)

(73) Assignee: HONDA MOTOR CO., LTD., Tokyo (JP)

(21) Appl. No.: 17/195,966

(22) Filed: Mar. 9, 2021

(30) Foreign Application Priority Data
Mar. 24, 2020 (JP) 2020-053101

(51) Int. Cl. B62J 45/20; B62J 45/41

(52) U.S. Cl. CPC B62J 45/20; B62J 45/41

(57) ABSTRACT

The present invention provides a saddle ride type vehicle including a sensing unit configured to sense a travel lane of a self-vehicle; and a control unit configured to control a travel position in a vehicle width direction of the self-vehicle so that the self-vehicle travels within the travel lane of the self-vehicle sensed by the sensing unit and on a side closer to an edge than a center of the travel lane.

### CROSS-REFERENCE TO RELATED APPLICATION(S)

This application claims priority to and the benefit of Japanese Patent Application No. 2020-053101 filed on Mar. 24, 2020, the entire disclosure of which is incorporated herein by reference.

### BACKGROUND OF THE INVENTION

### Field of the Invention

The present invention relates to a saddle ride type vehicle and a control apparatus.

### Description of the Related Art

A so-called lane keeping assist system (LKAS) which is a technology for controlling the steering of a vehicle in the vehicle width direction is proposed in Japanese Patent Laid-Open No. 2019-217846 as a technique for driving support of a vehicle (four-wheel vehicle) as typified by automobiles. In recent years, development and research of technology for applying an LKAS-related technique also to motorcycles (saddle ride type vehicles) has been advancing.

However, there are several problems where improvements should be made in applying techniques related to LKAS to motorcycles. For example, motorcycles are narrower in vehicle width than automobiles; therefore, they have a higher degree of freedom in travel position in the vehicle width direction. Accordingly, there is a desire to ensure a field of view and further improve safety by controlling the travel position of a self-vehicle (motorcycle) in the vehicle width direction to be more suitable in relation to vehicles traveling in the travel lane (ahead) of the self-vehicle or vehicles traveling in the opposite lane.

### SUMMARY OF THE INVENTION

The present invention provides a driving support technique suitable for a saddle ride type vehicle.

According to one aspect of the present invention, there is provided a saddle ride type vehicle including a sensing unit configured to sense a travel lane of a self-vehicle, and a control unit configured to control a travel position in a vehicle width direction of the self-vehicle so that the self-vehicle travels within the travel lane of the self-vehicle sensed by the sensing unit and on a side closer to an edge than a center of the travel lane.

Further objects, features and advantages of the present invention will become apparent from the following detailed description of the embodiments of the present invention with reference to the accompanying drawings.

### BRIEF DESCRIPTION OF THE DRAWINGS

FIG. 1 is a view illustrating a configuration of a saddle ride type vehicle as one aspect of the present invention.

FIG. 2 is a view illustrating a configuration of a saddle ride type vehicle as one aspect of the present invention.

FIG. 3 is a view illustrating a configuration of a steering mechanism.

FIG. 4 is a block diagram illustrating a configuration of a control apparatus.

FIG. 5 is a view for describing an LKAS in the present embodiment.

FIG. 6 is a view for describing an LKAS in the present embodiment.

FIG. 7 is a view for describing an LKAS in the present embodiment.

FIG. 8 is a view for describing an LKAS in the present embodiment.

FIG. 9 is a view for describing an LKAS in the present embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

In each drawing, arrows X, Y, and Z indicate directions perpendicular to each other; the X direction indicates the front-and-rear direction of the saddle ride type vehicle, the Y direction indicates the vehicle width direction (left-and-right direction) of the saddle ride type vehicle, and the Z direction indicates the up-and-down direction (height direction) of the saddle ride type vehicle. The left and right of the saddle ride type vehicle are left and right, respectively, in a case of viewing in the travel direction (moving direction) of the saddle ride type vehicle. Also, there are cases where the front and rear of the front-and-rear direction of the saddle ride type vehicle are simply referred to as the front and rear and cases where the inner side and the outer side in the vehicle width direction of the saddle ride type vehicle are simply referred to as the inner side and the outer side.

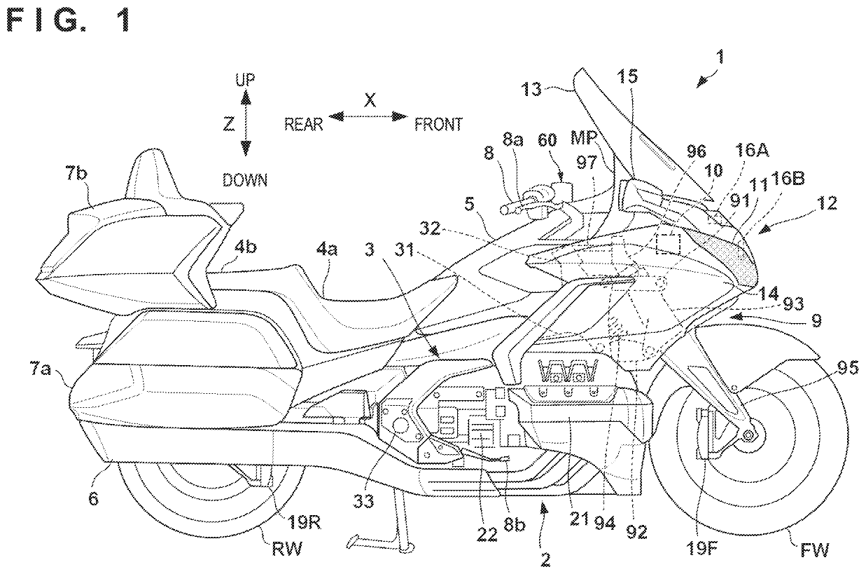

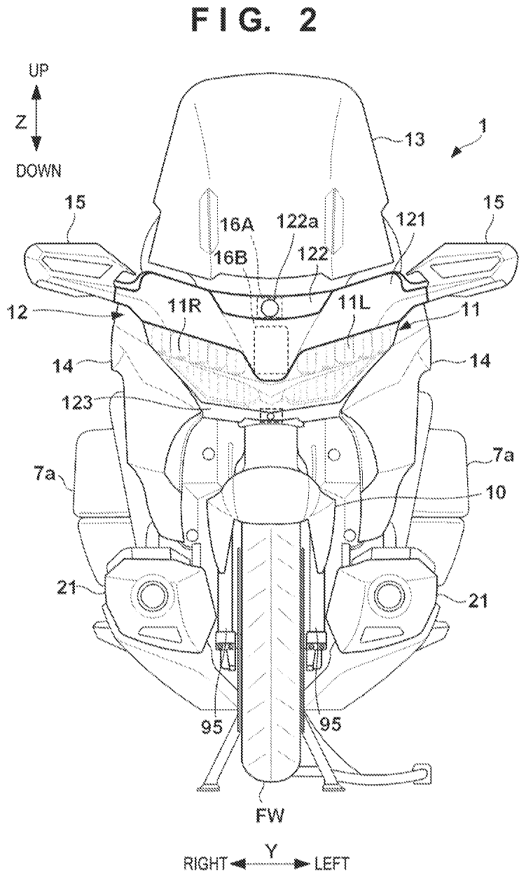

FIG. 1 and FIG. 2 are views illustrating a configuration of a saddle ride type vehicle 1 as one aspect of the present invention, and FIG. 1 is a side view from the right side of the saddle ride type vehicle 1 and FIG. 2 is a front view of the saddle ride type vehicle 1.

The saddle ride type vehicle 1, in the present embodiment, includes a front wheel FW and a rear wheel RW and is a tourer-type motorcycle suitable for traveling long distances. However, the present invention can be applied to various saddle ride type vehicles including other types of motorcycles.

The saddle ride type vehicle 1 includes a power unit 2 between the front wheel FW and the rear wheel RW. The power unit 2, in the present embodiment, is a driving source of an internal combustion engine, and includes an engine 21 and a transmission 22 for changing the speed of the output of the engine 21. Note that that the power unit 2 may use a motor as the driving source. The output (driving force) of the transmission 22 is delivered to the rear wheel RW via a drive shaft.

The power unit 2 is supported by a vehicle body frame 3. The vehicle body frame 3 includes a pair of left and right main frames 31 arranged to extend in the front-and-rear direction. A fuel tank 5 and such is positioned in the upper part of the main frames 31. A meter panel MP including a display apparatus for displaying various information in relation to a driver is provided in the front of the fuel tank 5.

A head pipe 32 for supporting a steering shaft to be pivoted by a handle 8 so as to be pivotable is provided in the front end portion of the main frames 31. A pair of left and right pivot plates 33 is provided in the rear end portions of the main frames 31. The lower end portion of the pivot plates 33 and the front end portion of the main frames 31 are connected via a pair of left and right lower arms, and the power unit 2 is supported by the main frames 31 and the lower arms. A pair of left and right seat rails extending in the rear direction is provided in the rear end portion of the main frames 31. The seat rails support a seat 4a on which the driver sits, a seat 4b on which a passenger sits, a rear trunk 7b, and the like.

The front end portion of a rear swing arm extending in the front-and-rear direction is supported on the pivot plates 33 so as to be swingable. The rear swing arm is configured to be swingable in the up-and-down direction. A rear wheel RW is supported at the rear end portion of the rear swing arm. An exhaust muffler 6 for muting the exhaust of the engine 21 is arranged to extend in the front-and-rear direction on the lower side of the rear wheel RW. Left and right saddlebags 7a are provided on the upper side of the rear wheel RW.

A front suspension mechanism 9 for supporting the front wheel FW is provided in the front end portion of the main frames 31. The front suspension mechanism 9 includes an upper link 91, a lower link 92, a fork support member 93, a cushion unit 94, and a pair of left and right front forks 95.

The upper link 91 and the lower link 92 are positioned at the front end portion of the main frames 31 having a space at the top and bottom, respectively. The rear end portion of each of the upper link 91 and the lower link 92 is connected to a supporting portion provided in the front end portion of the main frames 31 so as to be swingable. Also, the front end portion of each of the upper link 91 and the lower link 92 is connected to the fork support member 93 so as to be swingable. The upper link 91 and the lower link 92 respectively extend in the front-and-rear direction and, in effect, are positioned in parallel.

The cushion unit 94 has a structure in which a shock absorber is inserted into a coil spring. The upper end portion of the cushion unit 94 is supported by the main frames 31 so as to be swingable. The lower end portion of the cushion unit 94 is supported by the lower link 92 so as to be swingable.

The fork support member 93 has a cylindrical shape and tilts backward. The front end portion of the upper link 91 is connected to the upper front portion of the fork support member 93 so as to be pivotable. The front end portion of the lower link 92 is connected to the lower rear portion of the fork support member 93 so as to be pivotable.

A steering shaft 96 is supported by the fork support member 93 so as to be pivotable around its axis. The steering shaft 96 includes a shaft portion to be inserted into the fork support member 93. A bridge BG is provided on the lower end portion of the steering shaft 96. The pair of left and right front forks 95 is supported by the bridge BG. The front wheel FW is supported by the front forks 95 so as to be pivotable. The upper end portion of the steering shaft 96 is connected to the steering shaft to be pivoted by the handle 8 via a link 97. The steering shaft 96 is rotated by the steering of the handle 8, to thereby steer the front wheel FW.

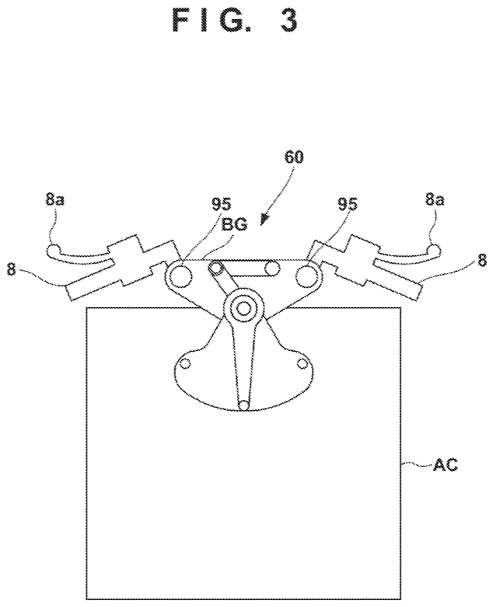

Each of the units described above related to the steering of the front wheel FW configures a steering mechanism 60 for steering the front wheel FW as illustrated in FIG. 1 and FIG. 3. FIG. 3 is a view illustrating a configuration of the steering mechanism 60. Note that in FIG. 3, only the handle 8, the front forks 95, and the bridge BG which are a portion of the steering mechanism 60 are illustrated. Also, in the present embodiment, as a technique for driving support related to the driver, a mechanism for automatically steering the front wheel FW via the steering mechanism 60, specifically, an actuator AC for applying a driving force for operating the handle 8 to the steering mechanism 60 in place of the driver is provided in relation to the steering mechanism 60. However, for the mechanism for automatically steering the front wheel FW, any technique known in the field can be applied.

The saddle ride type vehicle 1 includes a braking device 19F for braking on the front wheel FW and a braking device 19R for braking on the rear wheel RW. The braking devices 19F and 19R are configured to be operable by the operation of the driver related to a brake lever 8a or a brake pedal 8b. The braking devices 19F and 19R include a disc brake, for example. Also, in the present embodiment, as a technique for driving support related to the driver, an automatic braking mechanism for automatically operating the braking devices 19F and 19R in place of the driver is provided. For the automatic braking mechanism, any technique known in the field can be applied.

A headlight unit 11 for radiating light ahead of the saddle ride type vehicle 1 is provided in the front portion of the saddle ride type vehicle 1. The headlight unit 11 is configured, as illustrated in FIG. 2, by a two-lamp headlight unit in which a light emitting portion 11R and the light emitting portion 11L are positioned in bilateral symmetry. However, a one-lamp or three-lamp headlight unit or a bilaterally asymmetrical two-lamp headlight unit can be employed for the headlight unit 11.

The front portion of the saddle ride type vehicle 1 is covered by a front cowl 12, and the sides of the front of the saddle ride type vehicle 1 are covered by a pair of left and right side cowls 14. A screen 13 is positioned on the upper part of the front cowl 12. The screen 13 functions as a windshield for reducing wind pressure received by the driver while traveling and is configured by a transparent resin member, for example.

A pair of left and right side mirror units 15 is provided at the sides of the front cowl 12. A side mirror for the driver to see behind is supported by the side mirror units 15.

The front cowl 12, in the present embodiment, includes cowl members 121, 122, and 123. The cowl member 121 extends in the left-and-right direction and configures the main body of the front cowl 12, and the cowl member 122 configures the upper portion of the cowl member 121. The cowl member 123 is disposed apart in the downward direction from the cowl member 121.

An opening for exposing the headlight unit 11 is formed between the cowl member 121 and the cowl member 123 and between the pair of left and right side cowls 14. The upper edge of the corresponding opening is defined by the cowl member 121, the lower edge of the corresponding opening is defined by the cowl member 123, and the left and right side edges of the corresponding opening is defined by the side cowls 14.

Behind the front cowl 12, an image capturing unit 16A and a radar 16B are provided as sensing devices for sensing a state ahead of the saddle ride type vehicle 1. The image capturing unit 16A and the radar 16B, in the present embodiment, function as sensing devices for sensing the travel lane of the saddle ride type vehicle 1, in other words, a self-vehicle, or lines (white lines and the like) defining the travel lane. Also, the image capturing unit 16A and the radar 16B function as sensing devices for sensing the opposite lane to the travel lane of the self-vehicle or lines defining the opposite lane.

The image capturing unit 16A includes a capturing sensor such as a CCD image sensor and a CMOS image sensor and an optical system such as a lens and acquires images by capturing ahead of the saddle ride type vehicle 1. The image capturing unit 16A is positioned behind the cowl member 122 configuring the upper portion of the front cowl 12. An opening 122a penetrating the cowl member 122 is formed on the cowl member 122. The image capturing unit 16A captures ahead of the saddle ride type vehicle 1 via the opening 122a and then acquires images.

The radar 16B includes a millimeter-wave radar, for example. The radar 16B is provided behind the cowl member 121. Accordingly, the cowl member 121 is configured by a material such as resin which can transmit electromagnetic waves. By the existence of the cowl member 121, it is possible to make the existence of the radar 16B (sensing unit) inconspicuous in the front view of the saddle ride type vehicle 1 and avoid spoiling the appearance of the saddle ride type vehicle 1.

The image capturing unit 16A and the radar 16B are provided at the central portion in the left-and-right direction of the front cowl 12 in the front view of the vehicle. By providing the image capturing unit 16A and the radar 16B at the central portion in the left-and-right direction of the saddle ride type vehicle 1, it is possible to obtain a wider image capturing range and sensing range to the left and right ahead of the saddle ride type vehicle 1 and sense the state ahead of the saddle ride type vehicle 1 without overlooking anything. Also, by one image capturing unit 16A and one radar 16B, it is possible to monitor equally to the left and right ahead of the saddle ride type vehicle 1. Accordingly, the invention is particularly advantageous in a configuration in which not a plurality but one of each of image capturing unit 16A and radar 16B are provided.

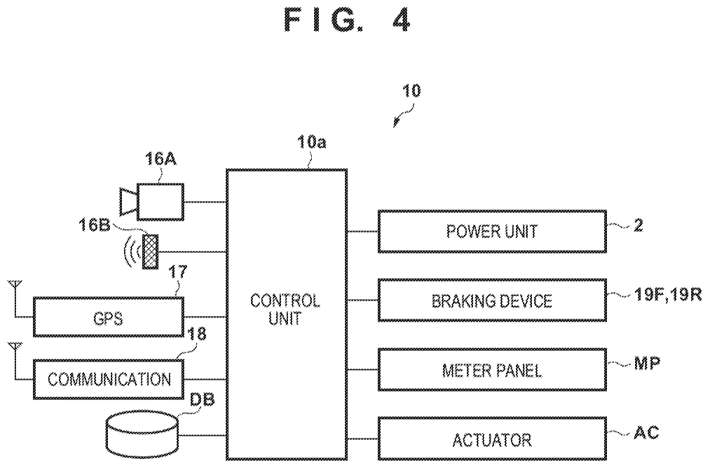

The saddle ride type vehicle 1 includes a control apparatus 10 for controlling each of the units (overall) of the saddle ride type vehicle 1. FIG. 4 is a block diagram illustrating a configuration of the control apparatus 10. The control apparatus 10 includes a control unit (ECU) 10a. A control unit 10a includes a processor as typified by a CPU, a storage device such as a semiconductor memory, an input/output interface or a communication interface with an external device. In the storage device, a program to be executed by the processor, data used for processing by the processor, and the like are stored. The control unit 10a may include a plurality of sets of a processor, a storage device, and an interface corresponding to each of the functions of the saddle ride type vehicle 1.

The control unit 10a acquires the result of sensing by the image capturing unit 16A and the radar 16B and constantly recognizes objects surrounding the saddle ride type vehicle 1 and the states of roads. Also, the control unit 10a acquires information from each of a GPS sensor 17, a communication apparatus 18, and a map information database DB. The GPS sensor 17 senses the position (current position) of the saddle ride type vehicle 1. The communication apparatus 18 performs wireless communication with a server which provides map information and traffic information and acquires the information. Highly accurate map information is stored in the map information database DB. The control unit 10a can identify the form of the road currently being traveled and the position of the saddle ride type vehicle 1 on the travel lane more accurately based on the map information stored in the map information database DB.

The control unit 10a can control the actuator AC, the braking devices 19F and 19R (of the automatic control mechanism), and the power unit 2 which provide the driving force for the steering mechanism 60. The control unit 10a, in the present embodiment, controls the actuator AC, the braking devices 19F and 19R, and the power unit 2 when providing, as a driving support technique, the lane keeping assist system (LKAS) for controlling the steering in the left-and-right direction (vehicle width direction) of the saddle ride type vehicle 1, in other words, for controlling the travel position in the left-and-right direction of the self-vehicle. Also, the control unit 10a can control the display of the meter panel MP. The control unit 10a, in the present embodiment, performs various warnings (displays) to the driver via the meter panel MP in LKAS.

Hereinafter, the LKAS in the present embodiment will be described. The LKAS is a function provided to the driver as a driving support technique as described above. When the sensing devices including the image capturing unit 16A and the radar 16B sense the travel lane of the self-vehicle (saddle ride type vehicle 1), it is displayed on the meter panel MP that LKAS can be performed, for example. Then, when the driver instructs to turn on LKAS via the meter panel MP, for example, the control unit 10a starts the LKAS. Note that here, left-hand traffic is assumed as the rules of the road for vehicles. Also, each of the processing for the LKAS described below is periodically and repeatedly executed by the control unit 10a.

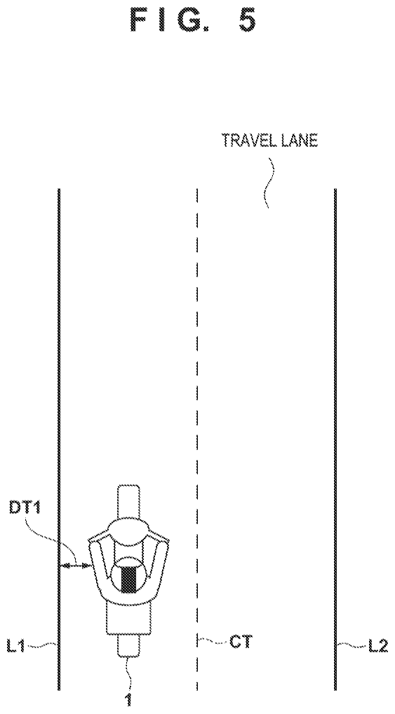

When the LKAS is started, the control unit 10a, as illustrated in FIG. 5, controls the travel position in the left-and-right direction (vehicle width direction) of the self-vehicle so that the self-vehicle travels at a position toward the edge of the travel lane of the self-vehicle, in other words, within the travel lane and on the side further to the edge than the center CT of the travel lane, where the edge is sensed by the sensing devices including the image capturing unit 16A and the radar 16B. In other words, the control unit 10a controls the travel position in the left-and-right direction of the self-vehicle so that within the travel lane, the self-vehicle travels proximate to a line L1 or L2 and in accordance with a line L1 or L2, which define the travel lane. The travel position in the left-and-right direction of the self-vehicle can be controlled by the control unit 10a controlling the actuator AC (steering the front wheel FW) which provides the driving force to the steering mechanism 60. By this, even in a case where there is a vehicle (preceding vehicle) that is traveling on the travel lane of the self-vehicle ahead of the self-vehicle, it is possible to ensure the field of view ahead of the driver and to improve the visibility ahead. Also, by improving the visibility ahead, the driver can predict (confirm in advance) sudden braking of the preceding vehicle resulting from the state ahead of the preceding vehicle (e.g., presence of an obstacle).

Also, as illustrated in FIG. 5, the control unit 10a may control, in the LKAS, the travel position in the left-and-right direction (vehicle width direction) of the self-vehicle (saddle ride type vehicle 1) so that a central position CT1 in the left-and-right direction of the self-vehicle coincides with a position that is apart by a predetermined distance DT1 in the vehicle width direction from the line L1 (or L2) defining the travel lane. By this, the control of the steering in the left-and-right direction of the saddle ride type vehicle 1, in other words, positioning in the left-and-right direction in the LKAS can be easily performed.

Note that, the predetermined distance DT1 may be set by default or may be enabled to be set as desired by the driver. When setting the predetermined distance DT1, setting may be performed taking into account the vehicle width of the saddle ride type vehicle 1 so that at least a portion of the saddle ride type vehicle 1 does not contact the line L1 (or L2) defining the travel lane. By this, in a case where the line L1 defining the travel lane is defined by a curb, it is possible to avoid the saddle ride type vehicle 1 from contacting the curb.

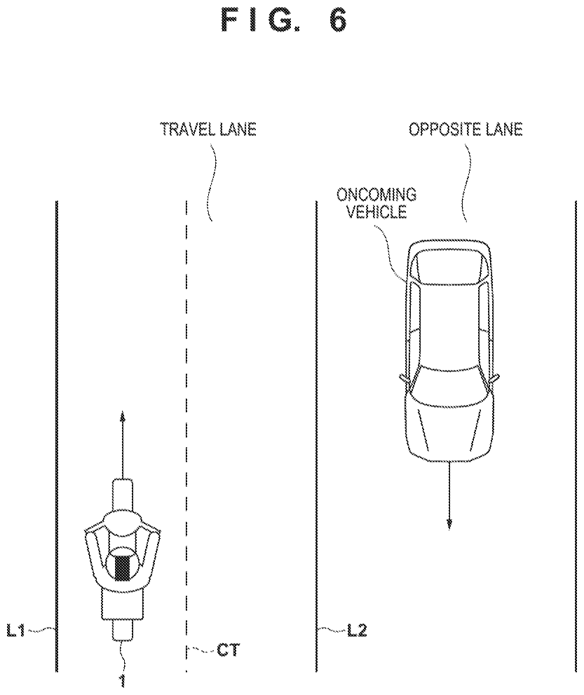

Also, the actual shape of the road is often such that there is an opposite lane to the travel lane of the self-vehicle (saddle ride type vehicle 1). Accordingly, as illustrated in FIG. 6, the control unit 10a controls, in the LKAS, the travel position in the left-and-right direction (vehicle width direction) of the self-vehicle so that the self-vehicle travels at a position toward the edge on the opposite side to the opposite lane of the travel lane of the self-vehicle, in other words, within the travel lane and at a position toward the edge on the opposite side to the opposite lane side, where the edge is sensed by the sensing devices including the image capturing unit 16A and the radar 16B. As illustrated in FIG. 6, in left-hand traffic, the opposite lane is on the right side in relation to the travel lane of the self-vehicle; therefore, the travel position in the left-and-right direction of the self-vehicle is controlled so that among the two lines L1 and L2 defining the travel lane, the self-vehicle travels proximate to the left line L1 and in accordance with the line L1. By this, it is possible to reduce the possibility that the self-vehicle will contact an oncoming vehicle (another vehicle) traveling on the opposite lane (i.e., avoid collision accidents) and to improve safety with respect to oncoming vehicles.

Also, sensing devices including the image capturing unit 16A and the radar 16B can sense an oncoming vehicle (another vehicle) traveling the opposite lane. Accordingly, as illustrated in FIG. 6, configuration may be taken so as to, in a case where the opposite lane is sensed, control the travel position in the left-and-right direction (vehicle width direction) of the self-vehicle (saddle ride type vehicle 1) so that the self-vehicle travels at a position toward the edge on the opposite side to the opposite lane of the travel lane of the self-vehicle, in other words, within the travel lane and at a position toward the edge on the opposite side of the opposite lane side.

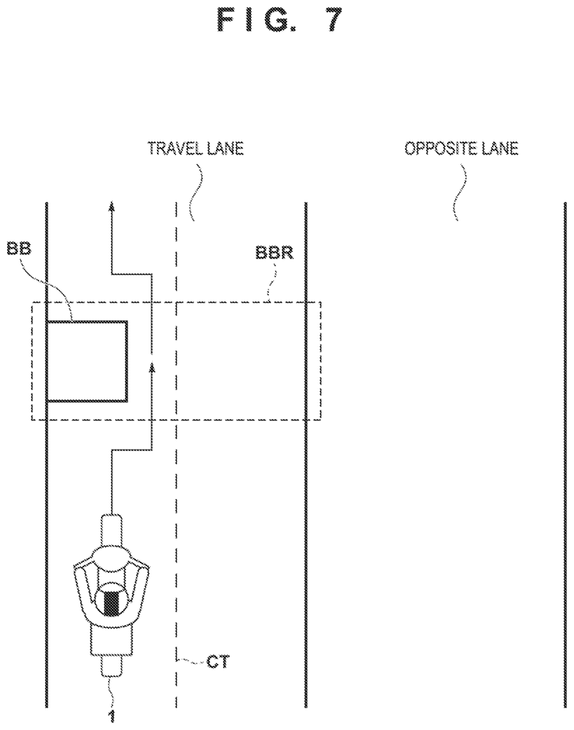

Also, the sensing devices including the image capturing unit 16A and the radar 16B can sense an obstacle present in the travel lane. Accordingly, as illustrated in FIG. 7, in a case where an obstacle BB is sensed, the travel position in the left-and-right direction (vehicle width direction) of the self-vehicle (saddle ride type vehicle 1) may be controlled so that the self-vehicle travels within the travel lane on the side of the edge that is opposite from the edge on the side on which the obstacle BB is present. In FIG. 7, the obstacle BB is on the left side; therefore, the travel position in the left-and-right direction of the self-vehicle is controlled so that among the two lines L1 and L2 defining the travel lane, the self-vehicle travels proximate to and in accordance with the line L2, which is on the right side. By this, even in a case where the obstacle BB is present ahead in the travel lane of the self-vehicle, it is possible to travel avoiding the obstacle BB. Note that the obstacle BB includes objects that make it difficult for the self-vehicle to travel such as a parked vehicle and a construction site.

Also, as illustrated in FIG. 7, in a case where the obstacle BB is sensed, the travel position in the left-and-right direction (vehicle width direction) of the self-vehicle (saddle ride type vehicle 1) may be controlled so that only in a region BBR in which the obstacle BB is present within the travel lane, the self-vehicle travels on the side of the edge that is opposite from the edge on the side on which the obstacle BB is present. Then, after the self-vehicle travels through the region BBR in which the obstacle BB is present, the travel position in the left-and-right direction of the self-vehicle may be controlled so that within the travel lane, the self-vehicle travels on the side of the edge on the side (left side in FIG. 7) on which the obstacle BB is present. By this, it becomes possible to, even in a case where the obstacle BB is present ahead in the travel lane of the self-vehicle, travel so as to avoid the obstacle BB and improve safety with respect to oncoming vehicles.

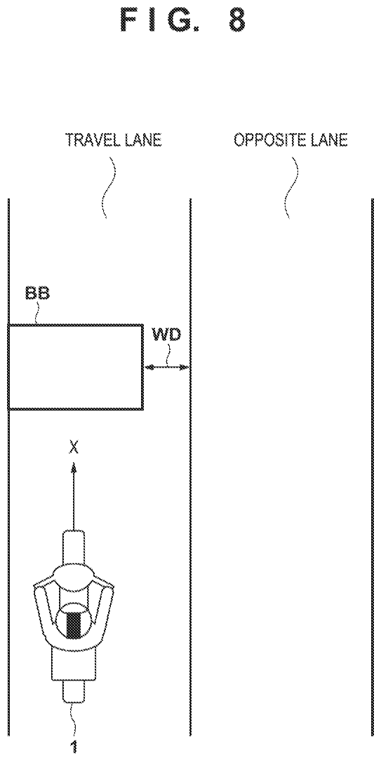

Also, in a case where the obstacle BB is present in the travel lane, depending on the size of the obstacle BB, there is a possibility that it may become difficult for the self-vehicle (saddle ride type vehicle 1) to travel on the travel lane. Accordingly, as illustrated in FIG. 8, a width WD between the obstacle BB and the edge on the side on which the obstacle is present in the travel lane is sensed by the sensing devices including the image capturing unit 16A and the radar 16B and in a case where the width WD is a predetermined width or less, the control unit 10a deactivates the LKAS and stops the self-vehicle from traveling. Stopping the self-vehicle from traveling can be controlled by the control unit 10a controlling (an automatic control mechanism of) the braking devices 19F and 19R. By this, in a case where an obstacle BB is present ahead in the travel lane of the self-vehicle and there is not enough space widthwise in the travel lane through which the self-vehicle can travel, it is possible to prevent the self-vehicle from colliding with the obstacle BB.

Note that the predetermined width to be compared with the width WD between the obstacle BB and the edge on the side on which the obstacle is present on the travel lane may be set by default or may be enabled to be set as desired by the driver. However, in order to prevent the self-vehicle (saddle ride type vehicle 1) from colliding with the obstacle BB, it is necessary that the predetermined width is set to the vehicle width of the self-vehicle or less.

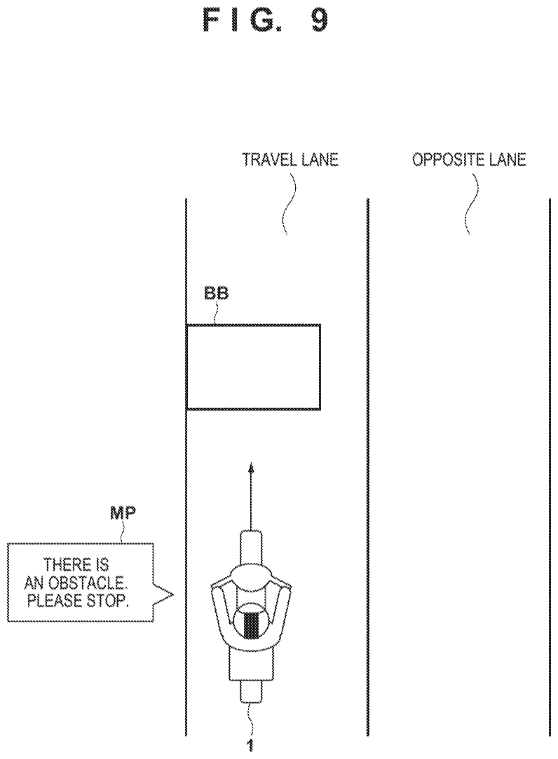

Also, in a case where the width WD between the obstacle BB and the edge on the side on which the obstacle is present in the travel lane is the predetermined width or less, the control unit 10a may not stop the self-vehicle (saddle ride type vehicle 1) from traveling but deactivate the LKAS and warn that it is difficult for the self-vehicle to travel. In the present embodiment, it is assumed that the actuation of warning is the displaying of an image related to the meter panel MP such as the displaying of “THERE IS AN OBSTACLE. PLEASE STOP.” related to the meter panel MP as illustrated in FIG. 9; however, the invention is not limited to this. The actuation of warning may be the lighting or blinking of a lamp or warning by audio. The actuation of warning by audio may be controlled so as to output the audio by wireless communication from a speaker provided on a helmet of the driver. By this, in a case where the obstacle BB is present ahead in the travel lane of the self-vehicle and there is no width in the travel lane through which the self-vehicle can travel, it is possible to prompt the driver to prevent the self-vehicle from colliding with the obstacle BB. Note that the traveling by self-vehicle may be stopped in addition to warning that there is a difficulty with respect to travel by the self-vehicle.

Note that in the present embodiment, it was described that, when controlling the travel position in the left-and-right direction of the self-vehicle in the LKAS, the actuator AC for providing the driving force to the steering mechanism 60 is controlled (the front wheel FW is steered). However, it goes without saying that the automatic braking mechanism of the braking devices 19F and 19R and the power unit 2 are controlled as necessary in addition to the control of the actuator AC.

A saddle ride type vehicle as a first embodiment of the present invention includes a sensing unit configured to sense a travel lane of a self-vehicle; and a control unit configured to control a travel position in a vehicle width direction of the self-vehicle so that the self-vehicle travels within the travel lane of the self-vehicle sensed by the sensing unit and on a side closer to an edge than a center of the travel lane.

According to the first embodiment of the present invention, it becomes possible to, even in a case where there is a preceding vehicle, ensure a field of view ahead of a driver and then a visibility ahead can be improved. Also, it becomes possible to predict sudden braking of the preceding vehicle resulting from a state ahead of the preceding vehicle.

In a saddle ride type vehicle as a second embodiment of the present invention, the control unit controls the travel position in the vehicle width direction of the self-vehicle so that within the travel lane of the self-vehicle sensed by the sensing unit, the self-vehicle travels on a side of an edge that is opposite to an edge on a side of an opposite lane to the travel lane.

According to the second embodiment of the present invention, it is possible to reduce a possibility that the self-vehicle will contact an oncoming vehicle traveling in the opposite lane and to improve safety in relation to oncoming vehicles.

In a saddle ride type vehicle as a third embodiment of the present invention, the sensing unit senses another vehicle traveling in the opposite lane and in a case where the other vehicle is sensed by the sensing unit, the control unit controls the travel position in the vehicle width direction of the self-vehicle so that within the travel lane of the self-vehicle sensed by the sensing unit, the self-vehicle travels on the side on the edge that is opposite from the edge on the side of the opposite lane.

According to the third embodiment of the present invention, it is possible to improve safety related to oncoming vehicles (another vehicle).

In a saddle ride type vehicle as a fourth embodiment of the present invention, the sensing unit senses an obstacle present in the travel lane of the self-vehicle, and in a case where the obstacle is sensed by the sensing unit, the control unit controls the travel position in the vehicle width direction of the self-vehicle so that within the travel lane of the self-vehicle sensed by the sensing unit, the self-vehicle travels on the side of the edge that is opposite from the edge on the side on which the obstacle is present.

By virtue of the fourth embodiment of the present invention, even in a case where an obstacle BB is present ahead in the travel lane of the self-vehicle, it is possible to travel avoiding the obstacle BB.

In a saddle ride type vehicle as a fifth embodiment of the present invention, the control unit controls the travel position in the vehicle width direction of the self-vehicle so that only in a region in which the obstacle is present within the travel lane of the self-vehicle sensed by the sensing unit, the self-vehicle travels on the side of the edge that is opposite from the edge on the side on which the obstacle is present.

By virtue of the fifth embodiment of the present invention, it becomes possible to travel so as to avoid the obstacle.

In a saddle ride type vehicle as a sixth embodiment of the present invention, the control unit controls the travel position in the vehicle width direction of the self-vehicle so that after the self-vehicle travels through the region, within the travel lane of the self-vehicle sensed by the sensing unit, the self-vehicle travels on the side of the edge on the side on which the obstacle is present.

By virtue of the sixth embodiment of the present invention, it becomes possible to travel to as to avoid obstacles and improve safety in relation to oncoming vehicles.

In a saddle ride type vehicle as a seventh embodiment of the present invention, in a case where the sensing unit senses an obstacle that is present in the travel lane of the self-vehicle and a width between the obstacle sensed by the sensing unit and the edge that is opposite to the edge on the side on which the obstacle is present on the travel lane of the self-vehicle is a predetermined width or less, the control unit causes the self-vehicle to stop traveling.

By virtue of the seventh embodiment of the present invention, in a case where an obstacle is present ahead in the travel lane of the self-vehicle and there is no width in the travel lane through which the self-vehicle can travel, it is possible to prevent the self-vehicle from colliding with the obstacle.

In a saddle ride type vehicle as an eighth embodiment of the present invention, in a case where the sensing unit senses an obstacle that is present in the travel lane of the self-vehicle and a width between the obstacle sensed by the sensing unit and the edge that is opposite to the edge on the side on which the obstacle is present in the travel lane of the self-vehicle is a predetermined width or less, the control unit warns that there is a difficulty with respect to traveling by the self-vehicle.

By virtue of an eighth embodiment of the present invention, in a case where an obstacle is present ahead in the travel lane of the self-vehicle and there is no width in the travel lane through which the self-vehicle can travel, it is possible to prompt the driver to prevent the self-vehicle from colliding with the obstacle .

In a saddle ride type vehicle as a ninth embodiment of the present invention, the predetermined width is set to a vehicle width of the self-vehicle or less.

By virtue of a ninth embodiment of the present invention, in a case where an obstacle is present ahead in the travel lane of the self-vehicle and there is no width in the travel lane through which the self-vehicle can travel, it is possible to advantageously prevent the self-vehicle from colliding with the obstacle.

A control apparatus of a saddle ride type vehicle as a tenth embodiment of the present invention includes a sensing unit configured to sense a travel lane of a self-vehicle, and a control unit configured to control a travel position in a vehicle width direction of the self-vehicle so that the self-vehicle travels within the travel lane of the self-vehicle sensed by the sensing unit and on a side closer to an edge than a center of the travel lane.

According to the tenth embodiment of the present invention, it becomes possible to, even in a case where there is a preceding vehicle, ensure a field of view ahead of a driver and improve forward visibility. Also, it becomes possible to predict sudden braking of the preceding vehicle resulting from a state ahead of the preceding vehicle.

The invention is not limited to the foregoing embodiments, and various variations/changes are possible within the spirit of the invention.

What is claimed is:

1. A saddle ride type vehicle comprising:
a sensing unit configured to sense a travel lane of a self-vehicle; and
a control unit configured to control a travel position in a vehicle width direction of the self-vehicle so that the self-vehicle travels within the travel lane of the self-vehicle sensed by the sensing unit and on a side closer to an edge than a center of the travel lane.

2. The saddle ride type vehicle according to claim 1, wherein the control unit controls the travel position in the vehicle width direction of the self-vehicle so that within the travel lane of the self-vehicle sensed by the sensing unit, the self-vehicle travels on a side of an edge that is opposite from an edge on a side of an opposite lane to the travel lane.

3. The saddle ride type vehicle according to claim 2, wherein the sensing unit senses another vehicle traveling in the opposite lane, and
in a case where the other vehicle is sensed by the sensing unit, the control unit controls the travel position in the vehicle width direction of the self-vehicle so that the self-vehicle travels, within the travel lane of the self-vehicle sensed by the sensing unit, on the side of the edge that is opposite to the edge on the side of the opposite lane.

4. The saddle ride type vehicle according to claim 1, wherein the sensing unit senses an obstacle present in the travel lane of the self-vehicle, and
in a case where the obstacle is sensed by the sensing unit, the control unit controls the travel position in the vehicle width direction of the self-vehicle so that within the travel lane of the self-vehicle sensed by the sensing unit, the self-vehicle travels on the side of the edge that is opposite from the edge on the side on which the obstacle is present.

5. The saddle ride type vehicle according to claim 4, wherein the control unit controls the travel position in the vehicle width direction of the self-vehicle so that only in a region in which the obstacle is present within the travel lane of the self-vehicle sensed by the sensing unit, the self-vehicle travels on the side of the edge that is opposite from the edge on the side in which the obstacle is present.

6. The saddle ride type vehicle according to claim 5, wherein the control unit controls the travel position in the vehicle width direction of the self-vehicle so that after the self-vehicle travels the region, within the travel lane of the self-vehicle sensed by the sensing unit, the self-vehicle travels on a side on the edge on the side on which the obstacle is present.

7. The saddle ride type vehicle according to claim 1, wherein the sensing unit senses an obstacle present on the travel lane of the self-vehicle, and
in a case where a width between the obstacle sensed by the sensing unit and the edge that is opposite from the edge on the side on which the obstacle is present in the travel lane of the self-vehicle is a predetermined width or less, the control unit causes the self-vehicle to stop traveling.

8. The saddle ride type vehicle according to claim 7, wherein the predetermined width is set to be a vehicle width of the self-vehicle or less.

9. The saddle ride type vehicle according to claim 1, wherein the sensing unit senses an obstacle present on the travel lane of the self-vehicle, and
in a case where a width between the obstacle sensed by the sensing unit and the edge that is opposite from the edge on the side on which the obstacle is present on the travel lane of the self-vehicle is a predetermined width or less, the control unit warns that it is difficult for the self-vehicle to travel.

10. The saddle ride type vehicle according to claim 9, wherein the predetermined width is set to be a vehicle width of the self-vehicle or less.

11. A control apparatus of a saddle ride type vehicle, the apparatus comprising:
a sensing unit configured to sense a travel lane of a self-vehicle; and
a control unit configured to control a travel position in a vehicle width direction of the self-vehicle so that the self-vehicle travels within the travel lane of the self-vehicle sensed by the sensing unit and on a side closer to an edge than a center of the travel lane.
